(19) United States
(12) Patent Application Publication
(10) Pub. No.: US 2023/0012056 A1
(43) Pub. Date: Jan. 12, 2023

(54) FILTER MEDIUM HAVING A NONWOVEN LAYER AND A MELT-BLOWN LAYER

(71) Applicant: NEENAH GESSNER GmbH, Bruckmühl (DE)

(72) Inventors: Andreas DEMMEL, Feldkirchen-Westerham (DE); Georg GEISBERGER, Bad Aibling (DE)

(21) Appl. No.: 17/664,849

(22) Filed: May 24, 2022

Related U.S. Application Data
(63) Continuation of application No. 16/968,444, filed on Aug. 7, 2020, now abandoned.

(30) Foreign Application Priority Data
Feb. 8, 2018 (DE) 10 2018 102 822.9

(51) Int. Cl. B01D 39/16

(52) U.S. Cl. CPC B01D 39/163; B01D 2239/0216; B01D 2239/1233; B01D 2239/0622; B01D 2239/125; B01D 2239/1258; B01D 2239/0627; B01D 2239/065

(57) ABSTRACT

A filter medium is disclosed having a nonwoven layer, which has bicomponent fibres, and a melt-blown layer, which comprises polyester fibres having an average diameter (d1) of less than 1.8 μm. The thickness of the nonwoven layer is less than 0.4 mm at a contact pressure of 0.1 bar. At least 25% of the polyester fibres of the melt-blown layer have a diameter (d) of less than 1 μm.

### CROSS RELATED APPLICATION

This application is a Continuation of U.S. application Ser. No. 16/968,444, filed Aug. 7, 2020, pending, which is the U.S. national phase of International Application No. PCT/EP2019/050773, filed Jan. 14, 2019, which designated the U.S. and claims priority to German Patent Application No. DE 10 2018 102 822.9, filed Feb. 8, 2018, the entire contents of each of which are hereby incorporated by reference.

### BACKGROUND

The present invention relates to a filter medium, which comprises a nonwoven layer having bicomponent fibres, and a melt-blown layer, and to a filter element having a filter medium of this kind.

The service life or lifetime of a filter element is the time which passes from the moment of the first use of the filter element until a specified maximum differential pressure is achieved. The larger the filtration surface of the filter element and the better the dust holding capacity of the filter medium (filter material) on the basis of its surface condition, the longer the service life.

The pressure difference indicates the difference in pressure which prevails upstream of and downstream of the filter material when the fluid to be filtered flows through the filter material.

The smaller the pressure difference, the higher the fluid flow rate at the specified pumping power. The pressure difference is smaller for a specified filter material and at a specified volume flow of the fluid to be filtered, the larger the filtration surface of a filter element is.

In order to achieve as large a filtration surface as possible, most filter materials are folded. However, the number of folds is limited by the size and geometry of the filter element.

In order for the folded material to also withstand high mechanical loads, the filter material has to be as stiff as possible. In order to achieve the desired stiffness, it is often necessary to use a thicker layer. However, the greater thickness of the filter material has the disadvantage that fewer folds can be formed, and therefore the available filter surface is reduced. This, in turn, negatively influences the dust holding capacity of the filter element and results in greater pressure loss.

The problem addressed by the invention is therefore that of providing a filter medium having a very good service life, efficiency, holding capacity and stiffness, and which furthermore offers the possibility of achieving a greater filter surface when folded. Furthermore, the filter material is intended to be the least brittle possible when used at high temperatures.

### SUMMARY OF THE INVENTION

According to the invention, the problem is solved by a filter material having the features of claim 1 and a filter element having the features of claim 15. Advantageous embodiments of the invention are described in the further claims.

### DETAILED DESCRIPTION OF THE INVENTION

The filter medium according to the invention comprises a nonwoven layer, preferably a spunbonded nonwoven layer, which has bicomponent fibres, and a melt-blown layer, which comprises polyester fibres having an average diameter less than 1.8 μm. The thickness of the nonwoven layer is less than 0.4 mm at a contact pressure of 0.1 bar. At least 25% of the polyester fibres of the melt-blown layer have a diameter of less than 1 μm.

Surprisingly, it has been shown that a very good service life, efficiency and stiffness is achieved by means of the combination according to the invention of the nonwoven layer which contains bicomponent fibres, and the melt-blown layer. In addition, a greater filter surface can be achieved when folded. Furthermore, the filter material is only slightly brittle when used at high temperatures and temperature fluctuations, for example underneath bonnets of motor vehicles or in gas turbines.

The filter medium according to the invention demonstrates no substantial physical changes and no drop in efficiency when exposed to a temperature of up to 160° 0.

The efficiency and the pressure loss of the filter medium of the present invention remain constant or at least substantially constant, even when the filter medium is exposed to a temperature of 140° C. and preferably of 160° C. for 15 minutes. The pressure loss of the filter medium does not increase more than 10% and preferably not more than 5% after the filter medium is exposed to a temperature of 140° C. for 15 min. The pressure loss of the filter medium does not increase more than 10% and preferably not more than 5% after the filter medium is exposed to a temperature of 160° C. for 15 min. The measurements were carried out as described below.

The dust holding capacity of the filter medium of the present invention remains constant or at least substantially constant, even when the filter medium is exposed to a temperature of 140° C., and preferably of 160° C., for 15 minutes. The dust holding capacity of the filter medium is not reduced more than 20% and preferably not more than 10% after the filter medium is exposed to a temperature of 140° C. for 15 min. The pressure loss of the filter medium is not reduced more than 20% and preferably not more than 10% after the filter medium is exposed to a temperature of 160° C. for 15 min. The measurements were carried out as described below.

The filter medium according to the invention has an efficiency of 35% (class F7), 50% (class F8) or 70% (class F9). The indicated efficiency corresponds to the minimal efficiency in percent at 0.4 μm DENS particles according to the standard DIN EN779:2012 (as described below).

The filter medium of the present invention has a basis weight of preferably 69 g/m²-180 g/m², more preferably of 80 g/m2 to 150 g/m² and particularly preferably of 90 to 130 g/m².

The air permeability of the filter medium is preferably 140-400l/m²s, and particularly preferably 150-250 l/m²s.

The thickness of the filter medium at a contact pressure of 0.1 bar is preferably 0.32 to 0.82 mm, particularly preferably 0.50 to 0.70 mm. The porosity of the filter medium of the present invention is preferably 70% to 90% and particularly preferably 80% to 90%.

The nonwoven layer, which is preferably a spunbonded nonwoven layer, preferably has a thickness of less than 0.40 mm according to DIN EN ISO 534 at a contact pressure of 0.1 bar. The thickness of the nonwoven layer is particularly preferably 0.25 to 0.38 mm and in particular 0.30-0.35 mm.

The basis weight of the nonwoven layer is 60 g/m²-120 g/m², preferably from 75 g/m² to 90 g/m², and particularly preferably 80 g/m².

The air permeability of the nonwoven layer is 1,000-3,500 l/m²s, preferably 1,800-2,800 l/m²s.

Every known method can be used to produce the nonwoven layer. The nonwoven layer preferably consists of a spunbonded nonwoven or a carded nonwoven. The nonwoven can be strengthened chemically and/or thermally. The nonwoven layer is particularly preferably a spunbonded nonwoven layer.

The nonwoven layer comprises or consists of bicomponent fibres. Bicomponent fibres consist of a thermoplastic material that has at least one fibre proportion having a higher melting point and a second fibre proportion having a lower melting point. The physical configuration of these fibres is known to a person skilled in the art and typically consists of a side-by-side structure or a sheath-core structure.

The bicomponent fibres can be produced from a large number of thermoplastic materials, including polyolefins (e.g. polyethylenes and polypropylenes), polyesters (such as polyethylene terephthalate (PET), polybutylene terephthalate (PBT) and PCT), and polyamides including nylon 6, nylon 6,6, and nylon 6,12, etc. The bicomponent fibres are preferably produced from polyesters. The bicomponent fibres particularly preferably consist of PET/CoPET.

The bicomponent fibres preferably have an average diameter of 10 to 35 μm, particularly preferably from 14 to 30 μm.

The melt-blown layer according to the invention comprises polyester fibres having an average diameter (d1) of less than 1.8 μm, preferably of 0.6 μm≤d1<1.8 μm, and particularly preferably of 0.60 μm≤d1≤1.75 μm, at least 25% and preferably 50% of the polyester fibres of the melt-blown layer having a diameter (d) of less than 1 μm, preferably 0.6≤d≤1 μm, and particularly preferably 0.60≤d≤0.95 μm. Preferably at least 25%, and particularly preferably at least 40% of the polyester fibres in the melt-blown layer have a diameter of 0.60≤d≤0.90 μm. The proportion of polyester fibres having a diameter of 0.6≤d≤0.85 μm is at least 25% and preferably at least 30%.

In the present invention, a distinction is made between the “average diameter” and the “diameter”. This distinction is therefore important, since the average diameter does not indicate any information about the amount of fine fibres having a specific diameter. The melt-blown layer of the present invention preferably has a basis weight of 9 g/m²-35 g/m², particularly preferably of 12 g/m² to 30 g/m², and in particular 18 g/m² to 24 g/m². The melt-blown layer preferably has an air permeability of 100-800 l/m²s, particularly preferably of 180 to 400 l/m²s, in particular of 180 to 300 l/m²s. The thickness of the melt-blown layer is preferably 0.07 to 0.22 mm, particularly preferably 0.10 to 0.16 mm.

The melt-blown process, which is known among people skilled in the art, is used to produce the melt-blown nonwoven according to the invention. Suitable polymers (in particular polyester) are, for example, polyethylene terephthalate or polybutylene terephthalate. The melt-blown layer preferably comprises polybutylene terephthalate fibres. The melt-blown layer particularly preferably consists of polybutylene terephthalate fibres. Depending on the requirements, other additives, such as hydrophilising agents, hydrophobing agents, crystallisation accelerators or paints can be admixed with the polymers. Depending on the requirements, the properties of the surface of the melt-blown nonwoven can be changed by means of a surface treatment method such as corona treatment or plasma treatment. The filter medium can either only consist of the combination of a nonwoven layer and a melt-blown layer or comprise one or more other layers.

The filter medium can comprise, in addition to the nonwoven layer and the melt-blown layer, a protective layer which protects the melt-blown layer. The protective layer can comprise a spunbonded nonwoven that is produced according to the spunbonded nonwoven method which is known to people skilled in the art. Polymers that are suitable for the spunbonded nonwoven method are e.g. polyethylene terephthalate, polybutylene terephthalate, polycarbonate, polyamide, polyphenylene sulphide, polyolefin, TPU (thermoplastic polyurethane) or mixtures thereof. The protective layer can have monocomponent fibres or bicomponent fibres. The protective layer preferably comprises monocomponent polyester fibres and particularly preferably polyethylene terephthalate fibres. In particular, the spunbonded nonwoven layer consists of monocomponent polyethylene terephthalate fibres.

The protective layer can also be created by means of a carding method or by means of a melt-blown process. Polymers that are suitable for the method are e.g. polyethylene terephthalate, polybutylene terephthalate, polycarbonate, polyamide, polyphenylene sulphide, and polyolefin or mixtures thereof.

The average diameter (d) of the fibres in the protective layer is 2 μm<d≤50 μm and preferably 5 μm<d≤30 μm and particularly preferably 10 μm<d≤20 μm.

The protective layer has a basis weight of 8 g/m²-25 g/m², preferably of 10 g/m² to 20 g/m², and an air permeability of 5,000-12,000 l/m²s, preferably of 6,800-9,000 l/m²s. The thickness of the protective layer at a contact pressure of 0.1 bar is 0.05 to 0.22 mm, preferably 0.05 to 0.16 mm.

The filter medium can also consist of the nonwoven layer, the melt-blown layer, and the protective layer.

The filter medium of the present invention is already flame-retardant without additional treatment. In this case, a value of B=0 is obtained e.g. according to the standard DIN 75200. However, the filter medium can also be equipped to be additionally flame-retardant.

During dynamic filtration, the flow direction is through the melt-blown layer or protective layer.

During static filtration, the flow direction is through the nonwoven layer.

In order to produce the filter medium, the melt-blown layer can be connected to the nonwoven layer, preferably the spunbonded nonwoven layer. For this purpose, every method known to a person skilled in the art can be used, such as a needling method, a water jet needling method, a thermal method (i.e. calender strengthening and ultrasound strengthening) and a chemical method (i.e. strengthening by means of an adhesive). The melt-blown layer is preferably connected to the spunbonded nonwoven layer by means of point calenders. The present invention also relates to a filter element, which comprises the filter medium. The filter element can additionally comprise another filter medium, which differs from the filter medium according to the invention, i.e. has different properties.

A particularly advantageous field of application for the filter medium according to the invention is that of gas turbines.

In the following, particularly advantageous embodiments will be described:

[1] Filter medium comprising a nonwoven layer, which has bicomponent fibres, and a melt-blown layer, which comprises polyester fibres having an average diameter of <1.8 μm, the thickness of the nonwoven layer being less than 0.4 mm at a contact pressure of 0.1 bar, and at least 25% of the polyester fibres of the melt-blown layer having a diameter d<1 μm.

[2] Filter medium according to [1], the nonwoven layer being a spunbonded nonwoven layer.

[3] Filter medium according to [1] and/or [2], the bicomponent fibres comprising at least one component which is selected from the group consisting of polyester, polyolefin, and polyimide.

[4] Filter medium according to any of [1] to [3], the bicomponent fibres comprising polyester fibres.

[5] Filter medium according to any of [1] to [4], the bicomponent fibres containing PET/CoPET.

[6] Filter medium according to any of [1] to [4], the nonwoven layer comprising or consisting of core-sheathe PET/CoPET bicomponent fibres.

[7] Filter medium according to any of [1] to [6], the thickness of the nonwoven layer being 0.25 mm to 0.38 mm, and more preferably 0.30 to 0.35 mm, at a contact pressure of 0.1 bar.

[8] Filter medium according to any of [1] to [7], the melt-blown layer comprising polyester fibres having an average diameter (d1) of 0.60 μm≤d≤1.75 μm.

[9] Filter medium according to any of [1] to [8], the melt-blown layer comprising polyester monocomponent fibres.

[10] Filter medium according to any of [1] to [9], the melt-blown layer comprising PBT.

[10] Filter medium according to any of [1] to [10], the melt-blown layer consisting of PBT.

[11] Filter medium according to any of [1] to [10], which comprises a protective layer, the protective layer comprising a spunbonded nonwoven layer or a melt-blown layer.

[12] Filter medium according to [10], the protective layer comprising monocomponent fibres.

[13] Filter medium according to any of [11] to [12], the protective layer comprising polyester fibres.

[14] Filter medium according to any of [11] to [13], the protective layer comprising PBT fibres or PET fibres.

[15] A gas turbine-filter medium, which comprises the filter medium according to any of [1] to [14].

[16] Filter element comprising a filter medium according to any of [1] to [15].

[17] Filter element according to [16], which further comprises a filter medium which differs from the filter medium according to any of [1] to [15].

Methods of Testing

Basis weight according to DIN EN ISO 536.

Thickness according to DIN EN ISO 534 at a contact pressure of 0.1 bar.

Air permeability according to DIN EN ISO 9237 at a pressure difference of 200 Pa.

Efficiency: The indicated efficiency values correspond to the minimum efficiency in percent for 0.4 μm particles according to DIN EN 779:2012 based on measuring flat specimens.

Pressure loss and dust holding capacity: Pressure loss along pressure difference-volume flow curves and dust holding capacity according to DIN71460-1.

Temperature resistance: The filter media are subjected to a temperature of 140° C. or 160° C. in a furnace for 15 minutes and then stored in a climatic chamber at 24° C. and 50% air humidity. After 24 hours in the climatic chamber at 24° C. and 50% air humidity, the filter media are measured again according to the methods of testing described here.

The porosity is calculated from the actual density of the filter medium and the average density of the used fibres according to the following formula:

Porosity=(1−density of filter medium [g/cm³]/density of fibres [g/cm³])*100%

Fibre Diameter

i. Principle of Measurement

Images are captured in a defined magnification by means of a scanning electron microscope. These are measured by means of automatic software. Measurement points, which record crossing points of fibres and thus do not represent the fibre diameter, are manually removed. Fibre bundles are generally considered to be one fibre.

ii. Appliances

FEI Phenom scanning electron microscope, having associated Fibermetric V2.1 software

iii. Implementation of the test

Sampling: nonwoven fabric at 5 points across the web width (at 1.8 m)

Capturing:

a. sputtering the sample

b. randomly capturing on the basis of optical images; the point found in this manner is captured at 1,000× magnification by means of the scanning electron microscope.

c. determining the fibre diameter by means of a “one-click” method; each fibre has to be recorded once.

d. average value and fibre diameter distribution are evaluated using Excel by means of the data obtained by Fibermetric.

The average fibre diameter per nonwoven is thus recorded in at least five points. The five average values are combined to form one average value. This value is designated the average fibre diameter of the nonwoven.

At least 500 fibres are evaluated.

Likewise, the percentage of fibres having a diameter ≤0.95 μm is recorded. e. Errors/standard deviation Standard deviation is presented.

### Example 1

A 19 g/m² PBT melt-blown material having a thickness of 0.12 mm and an air permeability of 280 l/m²s was connected to an 80 g/m² PET/CoPET spunbonded nonwoven having a thickness of 0.35 mm by means of point calenders. Afterwards, a 15 g/m² PET spunbonded nonwoven having a thickness of 0.11 mm and an air permeability of 7,500 l/m²s was applied to the melt-blown layer. In this case, the protective layer was adhesively bonded to the surface of the melt-blown layer.

The filter material according to the invention and obtained in this manner has a thickness of 0.60 mm, an air permeability of 160 l/m²s, a basis weight of 114 g/m² and a porosity of 88.3%.

### Comparative Example 1

A 19 g/m² PP melt-blown material having a thickness of 0.12 mm and an air permeability of 280 l/m²s was connected to an 80 g/m² PET/CoPET spunbonded nonwoven having a thickness of 0.35 mm by means of point calenders. Afterwards, a 15 g/m² PET spunbonded nonwoven having a thickness of 0.11 mm and an air permeability of 7,500 l/m²s was applied to the melt-blown layer. In this case, the protective layer was adhesively bonded to the surface of the melt-blown layer.

The filter material obtained in this manner has a thickness of 0.60 mm, an air permeability of 160 l/m²s, a basis weight of 114 g/m² and a porosity of 87.6%.

The filter medium of example 1 can be pleated very effectively and allows a high number of folds. At the same time, this filter medium demonstrates a very long service life, a very high level of efficiency, and excellent resistance to embrittlement. The filter medium actually demonstrates no substantial physical changes and no drop in efficiency after a temperature treatment at 160° C.

The pressure loss of the filter medium does not increase after the temperature treatment at 160° C. and the efficiency according to the standard EN779:2012 remains constant at 35% (class F7), 50% (class F8) or 70% (class F9).

In contrast, comparative example 1 shows an increase in the pressure loss even after a temperature treatment at 140° C. The dust holding capacity reduces significantly (˜75%).

1. A filter medium comprising a nonwoven layer, which has bicomponent fibres, and a melt-blown layer, which comprises polyester fibres having an average diameter (d1) of less than 1.8 μm, wherein the thickness of the nonwoven layer is less than 0.4 mm at a contact pressure of 0.1 bar, and at least 25% of the polyester fibres of the melt-blown layer have a diameter (d) of less than 1 μm.

2. The filter medium according to claim 1, wherein the filter medium has a basis weight of 69-180 g/m², an air permeability of 40-400l/m²s, a thickness of 0.32-0.82 mm and a porosity of 70-90%.

3. The filter medium according to claim 1, wherein the nonwoven layer is a spunbonded nonwoven layer.

4. The filter medium according to claim 1, wherein the nonwoven layer has a basis weight of 60-120 g/m², an air permeability of 1,000-3,500 l/m²s, and a thickness of 0.25-0.38 mm.

5. The filter medium according to claim 1, wherein the bicomponent fibres comprise at least one component selected from the group consisting of polyester, polyolefin, and polyamide.

6. The filter medium according to claim 1, wherein the bicomponent fibres contain PET/CoPET.

7. The filter medium according to claim 1, wherein the melt-blown layer comprises monocomponent fibres.

8. The filter medium according to claim 1, wherein the melt-blown layer comprises PBT fibres or consists of PBT fibres.

9. The filter medium according to claim 1, wherein the melt-blown layer has a basis weight of 9-35 g/m², an air permeability of 100-800l/m²s, and a thickness of 0.07-0.22 mm.

10. The filter medium according to claim 1, wherein the melt-blown layer comprises polyester fibres having an average diameter (d1) of 0.60 μm≤d≤1.75 μm.

11. The filter medium according to claim 1, wherein the filter medium additionally has a protective layer, which comprises a spunbonded nonwoven layer or a melt-blown layer.

12. The filter medium according to claim 11, wherein the protective layer comprises polyester fibres.

13. The filter medium according to claim 11, wherein the protective layer comprises monocomponent fibres.

14. The filter medium according to claim 11, wherein the protective layer comprises PBT fibres or PET fibres.

15. A filter element comprising a filter medium according to claim 1.

16. The filter element according to claim 15, which further comprises a filter medium which differs from the filter medium.
